(19) United States
(12) Patent Application Publication
(10) Pub. No.: US 2013/0050516 A1
(43) Pub. Date: Feb. 28, 2013

(54) IMAGING DEVICE, IMAGING METHOD AND HAND-HELD TERMINAL DEVICE

(71) Applicant: Daisuke HOJO, Narashino-shi (JP)

(72) Inventor: Daisuke HOJO, Narashino-shi (JP)

(21) Appl. No.: 13/592,814

(22) Filed: Aug. 23, 2012

(30) Foreign Application Priority Data
Aug. 31, 2011 (JP) 2011-190208

(51) Int. Cl. H04N 5/228

(52) U.S. Cl. 348/208.6; 348/E05.031

(57) ABSTRACT

An imaging device includes an imaging unit, a feature point extractor to extract feature points from at least one frame of image of a subject, a motion vector calculator to track each feature point over a series of images of a subject and calculate a motion vector of each feature point, a temperature measuring element to measure a temperature of a portion of the imaging device as temperature information, a positional shift estimator to estimate a shift amount of a position of the image on the basis of the temperature information, a weight calculator to weight each motion vector, referring to the estimated shift amount, a maximum likelihood calculator to calculate a maximum likelihood value of the shift amount of the position of the image from the weighted motion vector, and an image corrector to correct the image according to the maximum likelihood value of the shift amount.

### CROSS REFERENCE TO RELATED APPLICATION

The present application is based on and claims priority from Japanese Patent Application No. 2011-190208, filed on Aug. 31, 2011, the disclosure of which is hereby incorporated by reference in its entirety.

### BACKGROUND OF THE INVENTION

1. Field of the Invention

The present invention relates to an imaging device and an imaging method for compensating for the displacement of positioning of an anti-shake system which occurs due to a change in ambient temperature or temperature inside the imaging device.

2. Description of the Related Art

In prior art night scenes are photographed by various functions of a digital camera such as long time exposure or interval shooting. This type of shooting requires the use of a tripod or the like for long-time exposure to reduce camera shakes. There is a problem in long-time shooting that mechanical components as hall elements or magnets inside the camera are susceptible to temperature variation, which causes the center position of an anti-shake system to be gradually displaced. Also, with a long time exposure, the resolution of images is degraded.

Japanese Patent Application Publication No. 11-2852 (Reference 1), for example, discloses a shake correction controller for an optical device and a camera with shake correcting function which can perform stable, improved drive control irrespective of changes in ambient temperature. Specifically, this device comprises a temperature sensor to detect the ambient temperature of a camera body, a gain setting element to obtain a gain correction amount relative to a reference temperature according to the detected ambient temperature, and a drive control circuit to generate a reference gain according to a drive target position of a corrective lens unit, correct the reference gain by the gain correction amount and generate a drive signal for the corrective lens unit using the corrected reference gain.

For another example, Japanese Patent Application Publication No. 2001-223932 (Reference 2) discloses an imaging device as a digital camera to generate high-quality synthesized images with shifted pixels with no use of a mount such as a tripod. Specifically, in synthetic mode the device can identify a major subject by detecting a user's visual line with a visual line sensor in a viewfinder during through-the-lens image display. An image processor detects the blur amounts of the major subject and a background image by pattern matching of the through-the-lens images to control an image sensor driver to correct the blur amount of the major subject at shooting operation. This device is configured to issue warning when a blur in the major subject image is too large to correct and a difference in the blur amount between the major subject image and background image exceeds an allowable value due to translational blur.

However, the prior art imaging devices as above cannot prevent a deterioration in resolution and image quality in shooting night scenes with long-time exposure despite of using interval shooting function or a tripod. In particular, even a slight change in photographic composition during a several-hour shooting is intolerable in synthetic interval shooting mode since for the images captured by interval shooting, the brightness of pixels at the same coordinates are compared to extract ones with higher brightness and synthesize them.

Also, the displacement of the positioning of the anti-shake system may cause blurs in captured images or changes in photographic composition over time even at shooting with a tripod.

Lately, new models with no anti-shake system holder are available so that it is essential to find a solution to the above problems especially for devices with exposure for 180 seconds or synthetic interval shooting mode to maintain image quality.

FIGS. 5A to 5C show an image captured with no shift and images with simulated vertical and horizontal pixel shifts of 1.3 [px]. It is difficult to compensate for shift amount with accuracy of 1 to 2 [px] by merely correcting the position of the anti-shake system based on temperature data. As seen in the simulated image in FIG. 5, for example, a subject around limiting resolution is greatly decreased in contrast, which greatly degrades image quality.

FIGS. 6A to 6C show pixel shifts in an image captured in the synthetic interval shooting mode, with no shifts, with vertical shift of 5 [px], with horizontal shift of 10 [px], respectively, which are obviously unallowable degradation in image quality.

Meanwhile, in tracking feature points by image processing, it is possible to calculate a shift amount not affected by a variation in individual mechanical components or a change in ambient temperature. However, in this case image blurs occur due to a change in ambient light or presence of a moving subject. Note that more advanced compensation technique can be provided by concurrently calculating two different shift amounts.

Further, a variation in the output of the hall elements and magnets used in the anti-shake system is very large due to individual differences. Therefore, it is hard to accurately correct the variation by a uniform gain. To accurately correct the variation, the elements need to be individually adjusted.

FIG. 7 is a graph showing a relation between temperature change and pixel shift amount (calculated value) with the temperature characteristic of the hall element taken into consideration. As shown in the graph, approximate shift direction and amount of the anti-shake system can be calculated from temperature change information obtained from a temperature sensor. However, it is unable to deal with a variation in the individual elements or correction accuracy.

FIG. 8 shows an image as the result of tracking 100 feature points over continuous images by way of example. The shift amount of image or positioning of the anti-shake system can be calculated by tracking feature points over continuous images obtained by interval shooting. In the drawing circles represent the coordinates of the feature points of a first image and lines represent the motion of each feature point from start point to end point.

The shift amount can be found from sharp edges in an image at about sub-pixel accuracy. However, its accuracy may be decreased due to a fluctuation in brightness or the accuracy at which the feature points are tracked may be lowered by a change in ambient light or a subject. For example, in shooting the stars in the sky, if the stars are extracted as feature points, not the shift amount but the motion of the stars are calculated.

The motion of the feature points are mainly classified into three categories. The first one is the feature points of a still subject such as the 15^{th} feature point in FIG. 8. Such feature points are useful for detecting a shift in the positioning of the anti-shake system with no great ambient change. The shift of about 10 [px] is calculated as a tracking result while the shift visually checked is also 10 [px].

The second one is the feature points of a moving subject such as the 14^{th} feature point representing a slightly moving crane machine over time. These feature points cause noise which brings an error in the detection of displacement of the positioning.

The third one is the feature points of a star as the 0^{th} feature point. The motion of a bright star can be tracked but a dark star cannot be accurately tracked due to an influence from ambient noise. Therefore, this is useless information for calculating the displacement of the positioning.

Thus, in tracking stars, the motion of the feature points is at random and unexpectable, affected by noise or twinkling of stars. It is necessary to use reliable feature points. The use of temperature information is effective to select useful feature points for accurately calculating the displacement of the positioning. FIG. 9 shows the tracking result of 100 feature points over 395 continuous images captured at night. The subject is a still subject on a high-rise building as the 15^{th} feature point in FIG. 8. In this shooting the accuracy at which the feature points are tracked was gradually decreased over time at a level a photographer did not notice because of an insufficiently tightened clamp of a tripod. As a result, a difference of 10 [px] occurred between the first and last images. Thus, regarding the feature points of a still subject, the visual shift amount and that from the tracking result almost match each other.

FIG. 10 shows the tracking result of the 14^{th} feature point in FIG. 8 as a moving subject (craning machine on the high-rise building). It can be seen from the drawing that the feature point greatly moves in accordance with the motion of the moving subject. FIG. 11 shows the tracking result of the 0^{th} feature point as a star in FIG. 8

The device disclosed in Reference 1 is configured to control drive signals for an anti-shake system in accordance with an ambient temperature to compensate for the displacement of the positioning thereof. However, it cannot compensate for shifts in photographic composition with accuracy of 1 to 2 pixels over several-hour shooting. Further, the device disclosed in Reference 2 is to prevent camera shakes with no use of a tripod and is irreverent of the correction of the displacement of positioning of the anti-shake system.

### SUMMARY OF THE INVENTION

The present invention aims to provide an imaging device and an imaging method for compensating for displacement of the positioning of an anti-shake system due to a change in ambient temperature or temperature inside the device without reducing resolution over a long-time exposure, to generate high-quality images.

According to one aspect of the present invention, an imaging device comprises a lens barrel containing a lens group, an anti-shake system, an imaging unit to photoelectrically convert an optical signal of a subject to acquire an electric image, a feature point extractor to extract feature points from the image of at least one frame, a motion vector calculator to track each of the feature points over a series of images of the subject captured at plural times by the imaging unit and calculate a motion vector of each of the feature points, a temperature measuring element to measure a temperature of a portion of the imaging device as temperature information, a positional shift estimator to estimate a shift amount of a position of the image on the basis of the temperature information, a weight calculator to weight each motion vector obtained by the motion vector calculator, referring to the estimated shift amount, a maximum likelihood calculator to calculate a maximum likelihood value of the shift amount of the position of the image from the weighted motion vector, and an image corrector to correct the image according to the maximum likelihood value of the shift amount.

### BRIEF DESCRIPTION OF THE DRAWINGS

Features, embodiments, and advantages of the present invention will become apparent from the following detailed description with reference to the accompanying drawings:

FIG. 1 is a block diagram of the structure of an imaging device according to one embodiment of the present invention;

FIG. 2 is a flowchart for the synthetic interval shooting mode of the imaging device;

FIG. 3 is a graph showing a result of tracking feature points over 100 frames in full scale;

FIG. 4 is a graph showing a result of tracking feature points over 100 frames around 0 [px];

FIGS. 5A to 5C show images with a simulated shift in the positioning of the anti-shake system at normal shooting, with 1.3 pixels shifted horizontally, and with 1.3 pixels shifted horizontally and vertically, respectively;

FIGS. 6A to 6C show images with shifted pixels in the synthetic interval shooting mode, at normal shooting, with 5 pixels shifted horizontally, and with 10 pixels shifted horizontally and vertically, respectively;

FIG. 7 is a graph showing a relation between temperature change and pixel shift amount with the temperature characteristics of a hall element taken into account;

FIG. 8 shows a result of tracking the feature points by way of example;

FIG. 9 shows the trajectory of tracking the 15^{th} feature point of a still subject in an image;

FIG. 10 shows the trajectory of tracking the 14^{th} feature point of a moving subject in FIG. 8; and

FIG. 11 shows the trajectory of tracking the 0^{th} feature point of a star in FIG. 8.

### DETAILED DESCRIPTION OF PREFERRED EMBODIMENTS

The features of an imaging device according to one embodiment of the present invention are described below.

The imaging device can compensate for the displacement of positioning of an anti-shake system due to changes in ambient temperature or internal temperature of the device on the basis of shift direction and shift amount calculated from feature point tracking on image data and the same calculated from temperature information from a temperature measuring element. Thus, the imaging device generates high-quality images with no degradation in resolution even over a long-time exposure.

The temperature characteristics of a lens group, an image sensor, an anti-shake system are the factors which greatly affect image shifts. It is thus preferable to measure temperature at least one of the vicinity of the lens in a lens barrel, the back side of the image sensor, and the vicinity of the circuit of the image sensor.

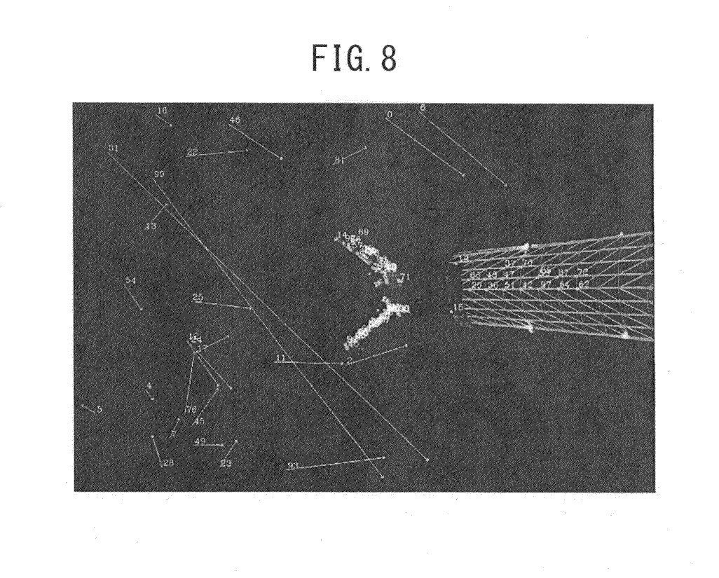

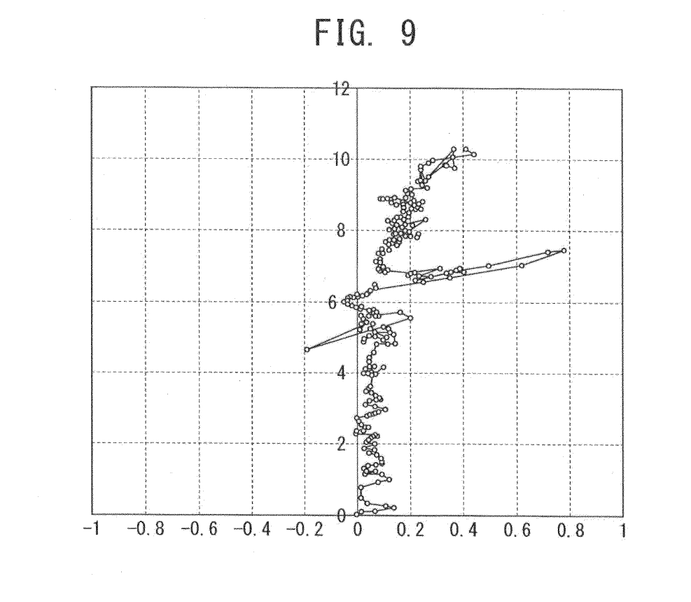

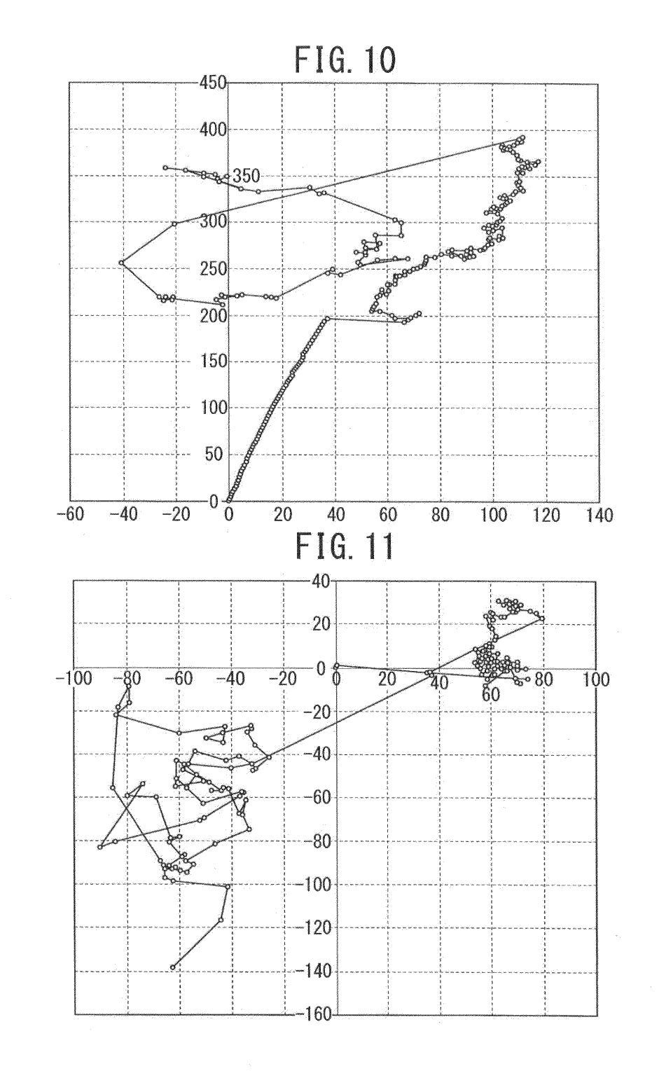

The tracking results of the feature points are not always reliable information for determining the displacement of positioning of the anti-shake system, for example, when no still subject is present in an image or a tracking failure occurs. The estimation from a temperature change is not very accurate but rather reliable than a tracking result including a failure. For example, when the feature points are of a moving object as a star or are unlikely to be successfully tracked in FIG. 8, the tracking results change in angle of view. Accordingly, using the tracking results for the estimation leads to degrading image quality. By acquiring information on how different the rough estimation from temperature information and the fine estimation from the feature point tracking are, it is possible to decide that the results of feature point tracking are not reliable and use only the estimation from temperature information.

Furthermore, to realize a relation that the tracking results=change in angle of view, ideal lenses with no aberration are needed. In reality due to lens distortion, the shift direction and amount of an image differ between the center and periphery of the image. With aberrations taken into account, the feature points around the image center are provided a larger weight and those in the periphery are provided a smaller weight. It is preferable to decide the weights with reference to the position of the lens group since aberrations vary according to focal length or in-focus position.

The number of the feature points can be arbitrarily set. It is preferable to decide weights for the feature points by Gauss function, for example so that the feature points are given smaller weights as they are away from the center of an image.

The shift amount obtained by the feature point tracking has a two-dimensional value of Cartesian coordinate (X, Y) or polar coordinate (R, θ). Assuming a feature point at coordinate (X, Y) where the value of X is very close to a roughly estimated shift amount from the temperature information but that of Y is far therefrom, this feature point is likely to be a tracking-failed feature point. Only the feature points with the two-dimensional values both close to the rough estimation are considered to be reliable. Thus, the use of Gaussian filter with two variables is preferable.

As described above, the imaging device is configured to select only reliable data from the shift amounts of images calculated from the feature point tracking by image processing during a long-time exposure or in interval shooting mode. The shift amounts are estimated from the information from the temperature sensor and used as parameters for the weighted mean calculation by Gaussian filter using two variables.

Hereinafter, embodiments of the present invention will be described in detail with reference to the accompanying drawings. Wherever possible, the same reference numbers will be used throughout the drawings to refer to the same or like parts.

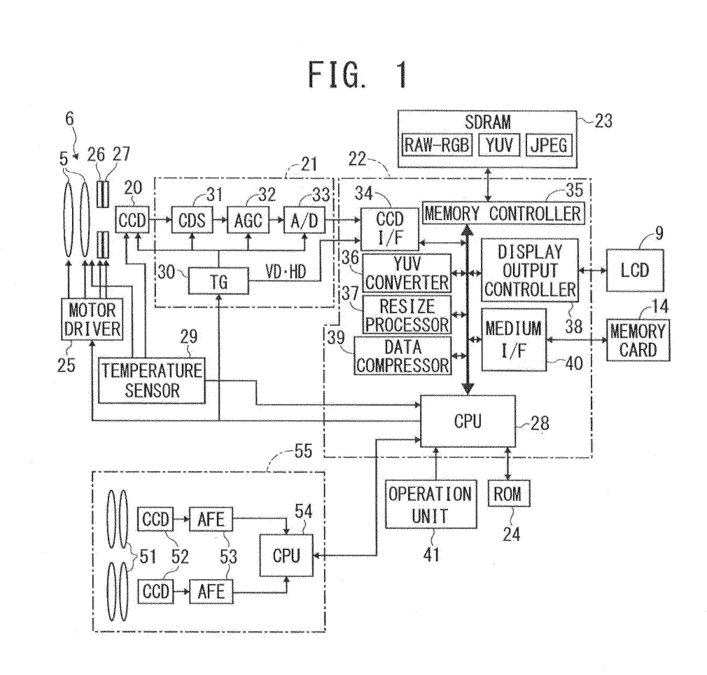

FIG. 1 shows the structure of a digital camera as an example of an imaging device according to one embodiment of the present invention. It comprises an optical system 6, an analog front end 21 to process analog signals, and a signal processor 22. The optical system 6 includes lens groups 5, an image sensor 20, a motor driver 25, an aperture diaphragm 26, an internal ND filter 27, and a temperature sensor 29.

The analog front end 21 includes a timing generator (TG) 30 to generate CCD drive signals, a CDS circuit 31 to remove noise from CCD output signals, an AGC circuit 32 to amplify signals for output, and an A/D converter 33 to convert analog signals into digital signals.

The signal processor 22 includes a CCD I/F 34, a controller 28 as CPU, a memory controller 35, a YUV converter 36, a resize processor 37, a display output controller 38, a data compressor 39, and a medium I/F 40. The image sensor 20 is a solid image sensor as a CCD or CMOD sensor. The analog front end 21 can be omitted by use of a CMOS sensor. The signal processor 22 is connected to an SDRAM 23, an ROM 24, an LCD 29, a memory card 14, and an operation unit 41. An external AF module 55 is an optical system and optional. The ROM 24 stores control programs written in codes readable by the controller 28 and parameters used for controlling the other elements.

The elements of the analog front end 21 are controlled by the controller 28 of the signal processor 22. The image sensor 20 photoelectrically converts optical images to electric image signals. The CDS 31 performs correlated double sampling on the image signals from the image sensor 20 to remove noise. The AGC 32 adjusts the gain of the noise-removed image signals, and the A/D converter 33 converts the gain-adjusted image signals to digital signals and output them to the signal processor 22. The CCD I/F 34 of the signal processor 22 temporarily stores image data from the A/D converter 33 at a timing given from the timing generator 30. The YUV converter 36, resize processor 37, and data compressor 39 compress the image data from the A/D converter 33. The display output controller 38 controls display on the LCD 29.

The medium I/F 40 controls the input and output of image data to/from the memory card 14. The operation unit 41 includes circuits connected to operation keys for users' manipulation, operation switches and buttons. The temperature sensor 29 is disposed near the optical system 6 in the lens barrel, at the back of the image sensor 20 as shown in FIG. 1, or near a not-shown anti-shake system to output electric signals corresponding to measured temperatures to the controller 28. The anti-shake system can be provided near the image sensor. The temperature characteristics of these elements greatly affect the shifts in images. Note that the structure of the imaging device in FIG. 1 is merely an example and it can be differently structured as long as it includes the temperature sensor 29.

The imaging device according to the present embodiment comprises a synthetic interval shooting mode. Recent digital cameras incorporate an interval shooting mode in which images are continuously shot with certain intervals. This mode is generally used when the camera is secured on a tripod or the like to continue to shoot a subject in the same composition. The synthetic interval shooting mode is an advanced interval shooting mode to compare the output values of the same pixels of continuously shot images and extract image data with high brightness for synthesis. This processing as referred to as lighten composite is a technique to capture the trajectories of stars or automobiles' headlights or taillights, or the trails of fireflies.

In the synthetic interval shooting mode the controller 28 of the imaging device performs the following processing:

First, a predetermined number of feature points are tracked over a certain number of images to find a shift amount or moving distance of each feature point.

Second, ambient temperature is measured with the temperature sensor 29 at each shooting operation to find an image shift amount corresponding to the measured temperature.

Third, each feature point is weighted on the basis of the image shift amount corresponding to the measured temperature to find a weighted mean value of the shift amounts obtained in the first processing.

The above three processings are described in detail in the following.

In the first processing the predetermined number of feature points are of not only a still subject but also a moving subject and the shift amounts thereof are calculated. Then, the feature points of a still object are given a high weight according to image shift amount data based on temperature information, to calculate weighted mean values. The types of feature points, still or moving, are indirectly discriminated according to the temperature information. In the second and third processing an importance is placed on the feature points of a still subject because the direction and amount of shift in an image cannot be accurately calculated unless the subject is completely still.

Specifically, the tracking results of the feature points of a moving subject are mostly motion vectors on the imaging plane. Therefore, data on the feature points of a moving subject is not useful and preferably excluded from the calculation of average image shift amounts. Thus, the feature points of a moving subject are given a very low weight. Meanwhile, the image of a still subject is assumed to be formed on the same point on the imaging plane over time so that the image shift amount on the imaging plane can be calculated from the motion vectors.

The imaging device according to the present embodiment uses the image shift amount corresponding to the temperature obtained in the above second processing for the calculation of average image shift amount as follows.

Tracking the feature points over images and finding the motion vectors is the most accurate way to calculate image shift amount and the feature points have to belong to a still subject. However, in actual photographic scenes a still subject and a moving subject are both present in general so that they need to be discriminated from each other. According to the present embodiment, the controller 28 is configured to indirectly select useful feature points by the weighted mean value calculation of image shift amounts to improve the accuracy of calculation. The shifts in images arise from an increase in the temperature of a camera body immediately after activation due to changes in the form of mechanical elements or changes in the property of electric elements. That is, how much an image shift occurs can be estimated by monitoring the temperature inside the camera body.

The controller 28 is configured of a means to track the feature points on images and find motion vectors in combination with a means to detect the temperature inside the camera body and estimate the image shift amount due to a temperature change. Thereby, it is possible to improve the accuracy of the estimation to a desired level irrespective of the accuracy of the temperature sensor 29, the influence from ambient temperature, and a dispersion in repetition.

Specifically, the controller 28 employs weighted mean calculation with Gaussian filter using two variables in which the feature points with low accuracy or likelihood are given a low weight. Thus, it can find the motion vector of a still subject on the imaging plane.

Further, the controller 28 is configured to set an estimated shift amount from a temperature change as a maximum likelihood position when determining that the maximal value of calculated weighted values is lower than a preset threshold.

The controller 28 also sets an estimated shift amount as a maximum likelihood position when determining that the number of the feature points with larger weights than a preset threshold is equal to or less than a preset number. Also, it can multiply the calculated weights by a coefficient, using coordinate information on the extracted feature points during shooting operation and information on the position of the lens groups of the imaging device.

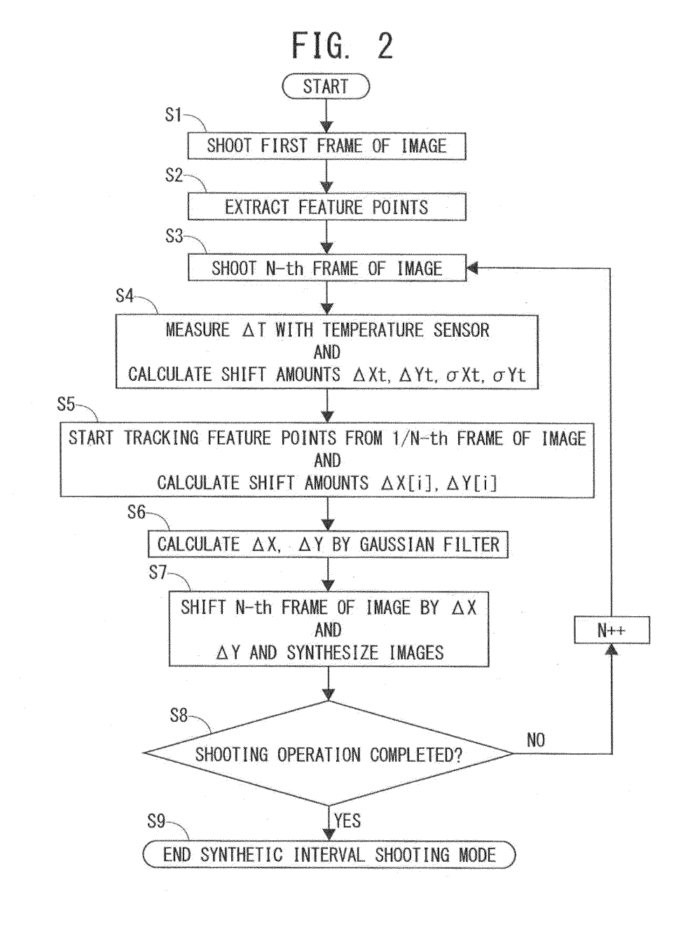

Referring to FIG. 1, the optical system 6 including aperture diaphragm, image sensor 20, analog front end 21, and signal processor 22 correspond to an imaging unit. The CPU 28 of the signal processor 22 corresponds to a feature point extractor and a motion vector calculator. The temperature sensor 29 corresponds to a temperature measuring element. The CPU 28 corresponds to a positional shift estimator and it calculates the shift amount of the position of a captured image from temperature information from the temperature sensor 29 and a shift amount table stored in the ROM 24. Further, the CPU 28 corresponds to a weight calculator and an image corrector. The configuration and operation of the above elements will be described with reference to FIG. 2.

The shift amount of positioning of the anti-shake system is calculated by simple average as the following expression (1):

ΔXavr=ΣΔX[i]/N, ΔYavr=ΣΔY[i]/N

where N is the number of feature points.
In this calculation outliers from a moving subject may be included so that its accuracy is low.

In view of this, the imaging device according to the present embodiment is configured to use weighted mean calculation with Gaussian filter using two variables to find the image shift amount, for example, to correct the 100^{th} image data captured which is described below.

In the present embodiment estimated shift amounts due to a temperature change are used. A Cartesian space (X, Y) is converted to a polar coordinate space (R, θ) for each of the feature points by the following expression (2):

R[i]=(ΔX[i]²+[i]²+Δ[i]²)^{1/2}

where ΔXt, ΔYt are the estimated values, “i” is an identifier of the feature point and σXt, σYt are a difference level of the estimated values with a variation in individual elements and measurement accuracy taken into account. Then, the weighted mean values of the image shift amounts are calculated by the following expressions (3) as weighted mean calculation with Gaussian filter using two variables, using the amount and direction of shift as parameters.

Rₐᵥᵣ=Σ([WRi]*Wθ[i]*R[i])/Σ(WR[i]*Wθ[i]),

θₐᵥᵣ=Σ(WR[i]*Wθ[i]*θ[i])/Σ(WR[i]*Wθ[i]),

WR[i]=Σ((Rₜ−R[i])²/(2*σRₜ²)/(σRₜ*(2π)^{(1/2)}),

Wθ[i]=Σ((θt−θ[i])²/(2*σθₜ²)/(σθₜ*(2π)^{(1/2)})

That is, in the expressions (3), the weights are determined by two-dimensional Gauss function with the center at an estimated shift amount (Rt, θt) found from temperature information. The dispersion σRt, σθt in R direction and θ direction is an amount determined by how far an estimated shift amount is from a correct value and by empirical rule such as the accuracy of the temperature sensor or dispersion in repetition.

As described above, to calculate the weighted mean values of shift amounts, the feature point with a shift amount far from an estimated shift amount is given a low weight while that with a shift amount close to the estimated shift amount is given a high weight.

Thus, the feature point with a shift amount (R direction) close to the estimated shift amount and a shift direction (θ direction) far from the estimated shift amount is determined to be low in reliability.

Note that the weighted mean values by the expression (2) are the maximum likelihood values Ravr, θavr. The present embodiment adopts the expression (3) for the weighted mean calculation. However, other calculations can be used. Also, Cartesian coordinate can be used in replace of polar coordinate. There is a calculation by Cartesian coordinate corresponding to the expression (3).

FIG. 2 is a flowchart for the synthetic interval shooting mode of the imaging device according to the present embodiment. Note that in the synthetic interval shooting mode the image compositions acquired by interval shooting are needed to match with accuracy of about 1 pixel, with image quality taken into account.

In step S1 the controller 28 captures a first image at start of the synthetic interval shooting mode.

In step S2 the controller 28 extracts feature points from the captured image. An arbitrary algorithm can be used for extracting the feature points. However, the good features to track algorithm is used herein to extract one hundred feature points.

This algorithm is used in KLT (Kanade-Lucas-Tomosi) feature tracking method. Harris operator is used for basic calculation, which is one of approaches based on differential geometry to find a portion with a large change in brightness from an image.

In step S3 the controller 28 continuously captures N-th images following the first image. The number N is an arbitrary integer and can be 100, for example.

In step S4 the controller 28 controls the temperature sensor 29 to measure a temperature change ΔT at present time and calculate estimated shift amounts ΔXt [px], ΔYt [px] and individual difference levels σXt, σYt. These parameters can be estimated by calculation from the temperature characteristic of a mechanical element as hall element or magnet or referring to a lookup table in which parameter values obtained by actually measuring the temperature characteristics of individual elements are stored.

In step S5 the controller 28 tracks the feature points through the first to N-th images and finds shift amounts ΔX[i], ΔY[i] according to the tracking results of the 100 feature points on the first to N-th images.

In step S6 the controller 28 converts the shift amounts ΔX[i], ΔY[i] to a polar coordinate space (R, θ) by the expression (2) and substitutes the resultants into the expression (3) to obtain Ravr and θavr in the (R, θ) space. Further, it converts the resultants, Ravr and θavr to a Cartesian space (X, Y) to find weighted mean shift amounts ΔX, ΔY in the (X, Y) space. Thus, weighting can be performed by Gaussian filter using two variables.

In step S7 the controller 28 shifts the N-th image by the weighted mean shift amounts ΔX, ΔY for synthesis.

In step S8 the controller 28 determines whether or not shooting operation is completed. Upon non-completion of the operation, it returns to step S3 while upon completion, it proceeds to step S9.

In step S9 the controller 28 has shot N+1 frames of image so that it ends the synthetic interval shooting mode.

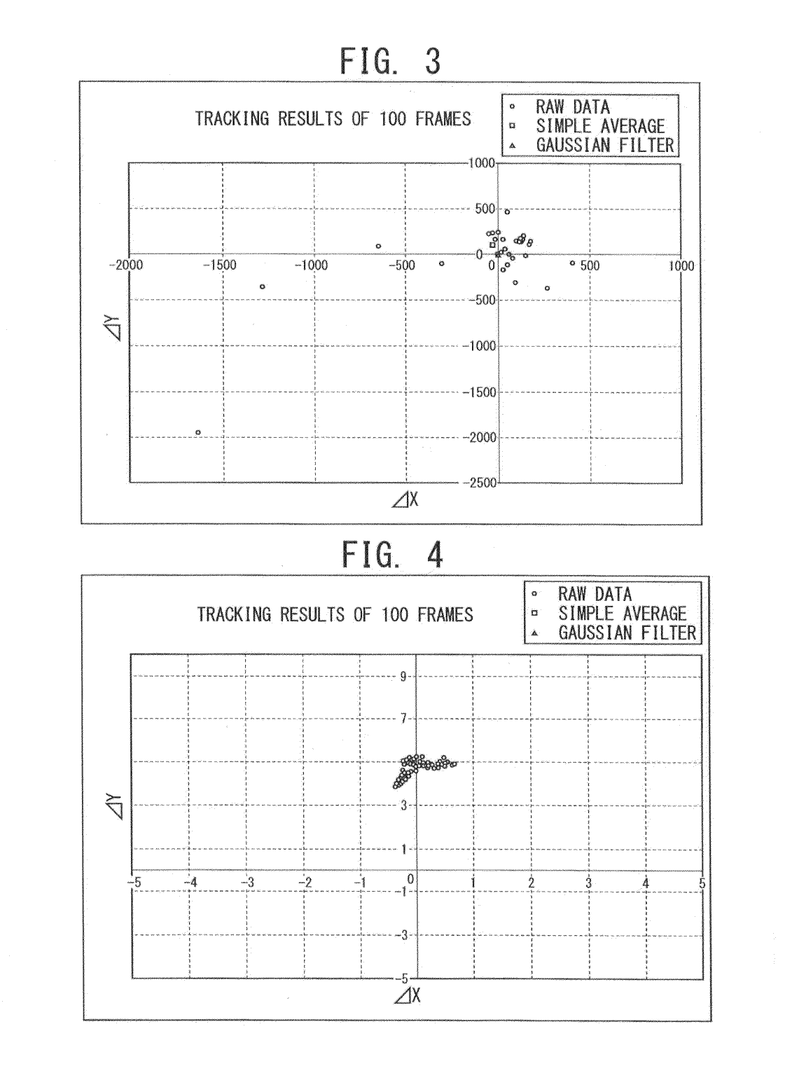

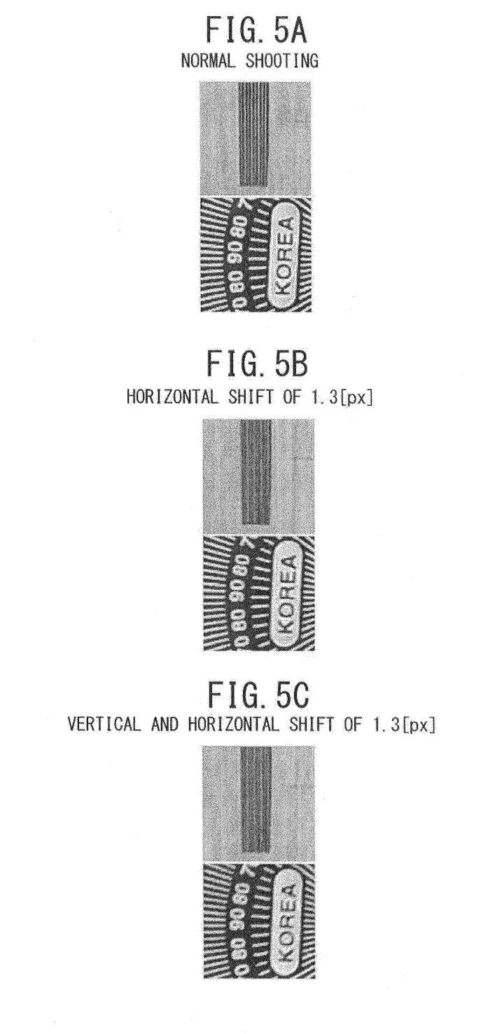

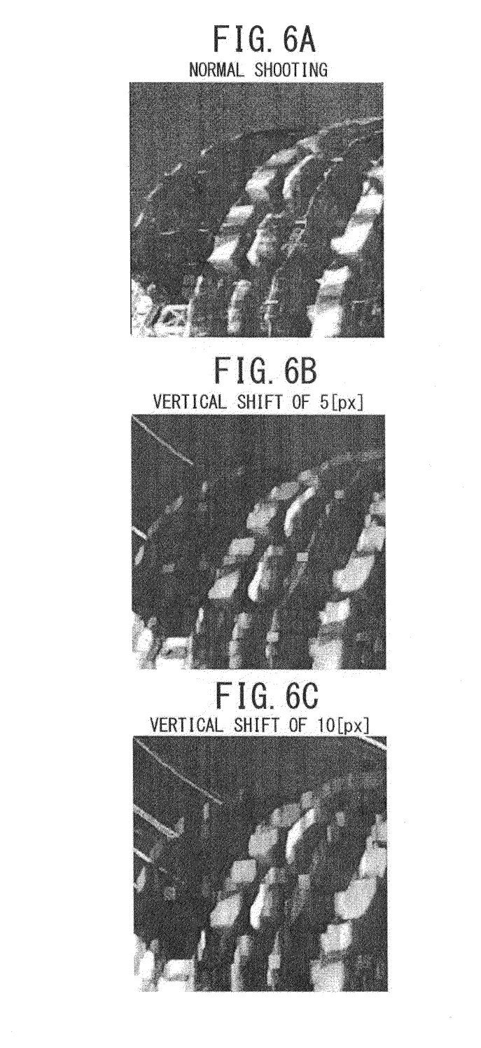

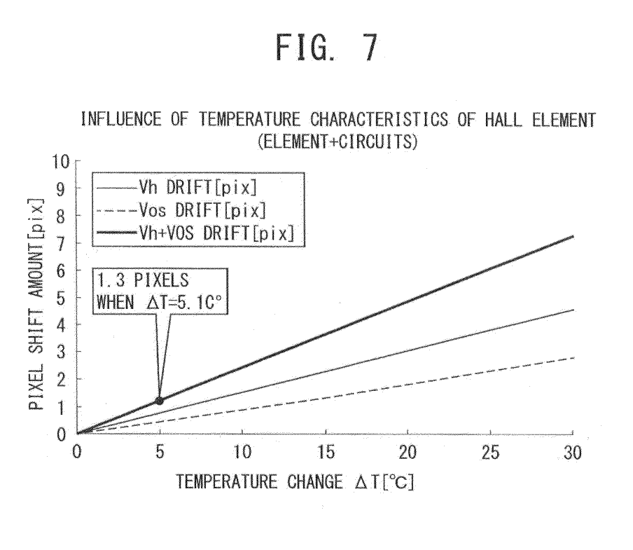

FIG. 3 is a graph in which the results of tracking the feature points in 100 frames of image in full scale are plotted while FIG. 4 is a graph showing the results around 0 [px]. FIGS. 3 and 4 show the same data in different scales. As seen from the graphs, ΔXavr=−25 [px] and ΔYavr=+101 [px] holds true when raw data including the feature points of an unsuccessfully tracked subject or a tracked moving object are simply averaged. By changing the weights using the expression (3) according to the type of the feature points, the weighted mean values are such that ΔXavr=−0.0 [px] and ΔYavr=+4.8 [px]. However, in the graphs a visual shift amount is 5.0 [px].

In the present embodiment desktop calculation is made on the assumption that Rt=5.0, θt=0, σθ=10. It is preferable that in reality estimated values (ΔRt, Δθt) are calculated on the basis of data from the temperature sensor 29.

At least a part of the processing of the respective elements of the imaging device can be executed with a computer. Further, a program to execute the processing shown in the flowchart of FIG. 2 can be stored in a computer readable medium such as semiconductor memory, CD-ROM or magnetic tape. The program can be read from the medium and executed by the computer including micro computer, personal computer, general-purpose computer. Also, the imaging device according to the present embodiment can be a hand-held terminal device with imaging function.

Although the present invention has been described in terms of exemplary embodiments, it is not limited thereto. It should be appreciated that variations or modifications may be made in the embodiments described by persons skilled in the art without departing from the scope of the present invention as defined by the following claims.

What is claimed is:

1. An imaging device comprising:
a lens barrel containing a lens group;
an anti-shake system;
an imaging unit to photoelectrically convert an optical signal of a subject to acquire an electric image;
a feature point extractor to extract feature points from the image of at least one frame;
a motion vector calculator to track each of the feature points over a series of images of the subject captured at plural times by the imaging unit and calculate a motion vector of each of the feature points;
a temperature measuring element to measure a temperature of a portion of the imaging device as temperature information;
a positional shift estimator to estimate a shift amount of a position of the image on the basis of the temperature information;
a weight calculator to weight each motion vector obtained by the motion vector calculator, referring to the estimated shift amount;
a maximum likelihood calculator to calculate a maximum likelihood value of the shift amount of the position of the image from the weighted motion vector; and
an image corrector to correct the image according to the maximum likelihood value of the shift amount.

2. An imaging device according to claim 1, wherein
the temperature measuring element is configured to measure the temperature of at least one of the vicinity of a lens inside the lens barrel, a back side of an image sensor, and the vicinity of a circuit of the anti-shake system.

3. An imaging device according to claim 1, further comprising
a maximum likelihood position controller to set the shift amount obtained by the positional shift estimator as a maximum likelihood position when determining that a maximal value of the weights calculated by the weight calculator is smaller than a preset threshold.

4. An imaging device according to claim 1, further comprising:
a maximum likelihood position controller to set the shift amount obtained by the positional shift estimator as a maximum likelihood position when determining that a number of the feature points with the weights over a preset threshold is a preset number or less.

5. An imaging device according to claim 1, wherein
the weight calculator is configured to multiply the weights calculated by the weight calculator by a coefficient, using coordinate information on the extracted feature points in the image and information on position of the lens group.

6. An imaging device according to claim 1, wherein
the weight calculator is configured to weight the motion vectors by Gauss function having a center at an estimated position calculated by the positional shift estimator and a dispersion as an amount determined from a reliability of the estimated position.

7. An imaging device according to claim 6, wherein
the weight calculator is configured to calculate the weights by weighted mean calculation with a Gaussian filter using two variables.

8. A hand-held terminal device comprising an imaging function and the imaging device according to claim 1.

9. An imaging method, comprising the steps of:
photoelectrically converting an optical signal of a subject to acquire an electric image;
extracting feature points from the image of at least one frame;
tracking each of the feature points over a series of images of the subject captured at plural times and calculating a motion vector of each of the feature points;
measuring a temperature of a portion of an imaging device as temperature information;
estimating a shift amount of a position of the image on the basis of the temperature information;
weighting each motion vector obtained in the motion vector calculating step, referring to the estimated shift amount;
calculating a maximum likelihood value of the shift amount of the position of the image from the weighted motion vector; and
correcting the image according to the maximum likelihood value of the shift amount.
